(19) United States
(12) Patent Application Publication
(10) Pub. No.: US 2004/0106379 A1
(43) Pub. Date: Jun. 3, 2004

(54) Wireless network communication system and method of connecting mobile station with wireless LAN access point automatically

(76) Inventors: Toshiaki Zen, Kanagawa (JP); Yoshikazu Kobayashi, Kanagawa (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/696,062

(22) Filed: Oct. 30, 2003

(30) Foreign Application Priority Data
Nov. 29, 2002 (JP) 348223/2002

(51) Int. Cl. H04Q 7/20

(52) U.S. Cl. 455/67.11; 455/426.2; 455/427; 455/456.1

(57) ABSTRACT

A mobile station in a wires network communication system includes a measuring unit, a map database, a control unit and a communication unit. The measuring unit measures a present position of the mobile station using radio wave. The map database stores a map data, which includes an identifier to identify of each of a plurality of wireless LAN access points connected to a wireless communications network. Also, the map data includes a connection data to communicate with each wireless LAN access point and a position data indicating a setting position of each wireless LAN access point. The control unit refers to the map database based on the present position of the mobile station to choose an optimal wireless LAN access. The communication unit communicates with another station through the optimal wireless LAN access point based on the connection data of the optimal wireless LAN access point.

### BACKGROUND OF THE INVENTION

1. Field of the Invention

The present invention relates to a method for automatically connecting a mobile station to a wireless LAN (Local Area network) access point in a wireless LAN communication system and a mobile station and an access point for the same.

2. Description of the Related Art

The technique is known which connects a mobile communication terminal (hereinafter described as a “mobile station”) and a wireless LAN access point during a communication between a station and another. When communication is carried out between the mobile station and the other mobile station, it is needed to set a wireless LAN access point previously so that the mobile station can be connected with the wireless LAN access point. For example, when the mobile station is out of a service area where the wireless LAN communication is possible, the mobile station does not recognize the position itself although it recognize the positions of plural wireless LAN access points. This makes it difficult to set the wireless LAN access point for the mobile station. This is the reason why the mobile station can not communicate promptly when it goes into the service area again. Therefore, it is desired to promptly set and connect the mobile station to a wireless LAN access point and to execute a roaming from the wireless LAN access point set previously to the wireless LAN access point to be set over again.

The technique in which a terminal changes an optimal access point is disclosed in Japanese Laid Open Patent Application JP-A-2000-194633A. The terminal of this conventional example positions a current position for terminal itself, and automatically sets up the access point nearest to the current position.

Also, the technique of detecting the access point which is optimal to a terminal is disclosed in Japanese Laid Open Patent Application JP-A-2001-095058A. The terminal of this conventional example receives a signal from a GPS Satellite in response to start of an application program, and generates the coordinates data of the current position of a self-terminal.

Also, the technique in which a terminal calculates a current position for terminal itself, and the access point nearest to the current position is automatically set up is disclosed in Japanese Laid Open Patent Application JP-A-Heiseill-201769A.

Also, the technique disclosed in Japanese Laid Open Patent Application JP-A-2001-308866A stores addition data in a terminal. The addition data is a charge for every access point, the field intensity for every access point, etc. The terminal sets up an access point based on the stored addition data.

The technique in which before a terminal moves out of a service area, another access point is automatically set up is disclosed in Japanese Laid Open Patent Application JP-A-2002-026931A.

The technique in which when a terminal is in the wireless-communication area outside of a service circle of an access point, the power supply to a device is turned off is disclosed in Japanese Laid Open Patent Application JP-A-2002-135824A.

### SUMMARY OF THE INVENTION

Therefore, an object of the present invention is to provide a mobile station, a wires network communication system and a method for automatic connection of the mobile station to an wireless LAN access point, in which setting and connection can be automatically executed and roaming can be promptly executed.

Another object of the present invention is to provide a mobile station, a wires network communication system and a method for automatic connection of the mobile station to an wireless LAN access point, in which setting and connection is executed on the basis of a priority of the wireless LAN access point desired by the user.

Still another object of the present invention is to provide a mobile station, a wires network communication system and a method for automatic connection of the mobile station to an wireless LAN access point, in which it is possible to reduce a electric power consumption.

It is also an object of the present invention to provide a mobile station, a wires network communication system and a method for automatic connection of the mobile station to an wireless LAN access point, in which the mobile station is automatically connected to an optimal wireless LAN access point when said mobile station communicates with another mobile station.

In an aspect of the present invention, a mobile station includes a measuring unit, a map database, a control unit and a communication unit. The measuring unit measures a present position of the mobile station using radio wave. The map database stores a map data, which includes an identifier to identify of each of a plurality of wireless LAN access points connecting to a wireless communications network, a connection data to communicate with each wireless LAN access point and a position data indicating a setting position of each wireless LAN access point. The control unit refers to the map database based on the present position of the mobile station to choose an optimal wireless LAN access point from the plurality of wireless LAN access points based on the present position of the mobile station. The communication unit that communicates with another station based on the connection data of the optimal wireless LAN access point.

In another aspect of the present invention, the mobile station further includes a setting table. The measuring unit calculates a distance between the present position of the mobile station and the setting position of each wireless LAN access point in response to completion of measuring the present position. In addition, the map data may further include a maximum transmission distance of each wireless LAN access point. In addition to the identifier, the connection data and the position data of each wireless LAN access point. The control unit refers to the map database and chooses the nearest optimal wireless LAN access point from the present position of the mobile station on condition that the distance is smaller than the maximum transmission distance of each wireless LAN access point. The control unit sets the connection data of the optimal wireless LAN access point in the setting table. The communication unit refers the setting table to communicate with the optimal wireless LAN access point.

In this case, the measuring unit measures the present position of the mobile station by a communication with GPS (Global Positioning System) satellite or a PHS (Personal Handyphone System) communication.

In another aspect of the present invention, the mobile further includes a power unit, which supplies electric power to the measuring unit, the control unit and the communication unit. When the mobile station does not exist in a location where it is possible to communicate with any of the plurality of wireless LAN access points. The control unit controls the power unit to stop supplying electric power to the communication unit. When the measuring unit measures the present position by using the radio wave, the control unit refers to the map database and chooses the optimal wireless LAN access point from the plurality of wireless LAN access points. When the mobile station exists in a location where it is possible to communicate with any of the plurality of wireless LAN access points. The control unit controls the power unit to supply electric power to the communication unit, and the communication unit communicates with the optimal wireless LAN access point based on the connection data of the optimal wireless LAN access point.

In another aspect of the present invention, the map database further contains a setting data provided for each of the plurality of wireless LAN access points and indicating a received electric field strength. The control unit refers to the setting data based on preset received electric field strength. Then the control unit determines a group of wireless LAN access points based on the setting data, and chooses the optimal wireless LAN access point from the group of wireless LAN access points.

In this case, each of the plurality of wireless LAN access points transmits through radio wave to the mobile station. The communication unit receives the radio wave to detect the received electric field strength of the radio wave. The control unit sets the received electric field strength in the setting data each wireless LAN access points.

In another aspect of the present invention, the map database further contains a traffic quantity data indicating a traffic quantity in communication of the mobile station with each of the plurality of wireless LAN access points. The control unit refers to the traffic quantity data based on a preset traffic quantity data. Then the control unit determines a group of wireless LAN access points based on the setting data and chooses the optimal wireless LAN access point from the group of wireless LAN access points.

In this case, the communication unit of the mobile station detects the traffic quantity data in a communication with each of the plurality of wireless LAN access points. The control unit set the detected traffic quantity data in the setting data for the each wireless LAN access point.

In another aspect of the present invention, the map database of the mobile station further contains a setting data provided each of the plurality of wireless LAN access points to indicate a connection fee. The control unit refers to the setting data based on a preset connection fee. The control unit determines a group of wireless LAN access points based on the setting data and chooses the optimal wireless LAN access point from the group of wireless LAN access points.

In another aspect of the present invention, the map database further contains a setting data provided for each of the plurality of wireless LAN access points to indicate a service area of each wireless LAN access point. The control unit refers to the setting data based on a preset service area. The control unit determines a group of wireless LAN access points based on the setting data and chooses the optimal wireless LAN access point from the group of wireless LAN access points.

In another aspect of the present invention, the communication unit of the mobile station downloads the latest map data from an ISP server connected to the wireless communications network during the communication. The latest map data contains an updated data of the optimal wireless LAN access point in the plurality of wireless LAN access points. The control unit stores the latest map data in the map database.

In another aspect of the present invention, the communication unit communicates with each of the plurality of wireless LAN access points based on a setting data for the each wireless LAN access point. The communication unit keeps a QoS (Quality of Service) constant.

In another aspect of the present invention, the mobile station includes a display unit. The map database stores the map data, which further includes a service data of buildings in a neighborhood of each of the plurality of wireless LAN access points. The control unit refers to the map data and controls the display unit to display the service data of the optimal wireless LAN access point.

In another aspect of the present invention, the mobile station includes a communication table. The communication table stores an identifier of a counter station, data of the counter station and a keyword. The communication unit refers to the communication table to inform the counter station of the present position corresponding to the keyword in case that a data in the communication includes the keyword.

In an aspect of the present invention, a method of an automatic connection to a wireless LAN access point in a wireless LAN communication system is achieved by (a) measuring a present position of a mobile station by a radio wave; by (b) choosing an optimal wireless LAN access point based on the present position from a plurality of wireless LAN access points by referring a map database storing a map data, by (c) communicating with a counter station based on the connection data of the optimal wireless LAN access point, by (d) downloading the latest map data from an ISP server which is connected to the wireless communications network, when the communication is carried out, and by (e) storing the latest map data into the map database as the map data. In this case, the map database stores the map data which includes an identifier of each of the plurality of wireless LAN access points connected to a wireless communications network, a connection point of the-each wireless LAN access point and a connection data needed to communicate with the each wireless LAN access point.

Here, the method may further include (f) calculating a distance between the present position and the connection point, and (g) choosing the optimal wireless LAN access point which is the nearest to the mobile station from the plurality of wireless LAN access points on condition that the distance is smaller than a maximum transmission distance by referring to the map database. The plurality of wireless LAN access points measures the connection points using the radio wave.

In addition, in the method, the present position may be measured by communication with GPS satellite or a PHS communication.

Also, the method may further include (h) setting the connection data of the optimal wireless LAN access point to a setting table, and (c) communicating includes acquiring the connection data of the optimal wireless LAN access point by referring to the setting table.

In this case, in the method, the (a) measuring and the (b) choosing is desirably executed when the mobile station does not exist in a service area of any of the plurality of wireless LAN access point. Also, the (c) communicating is desirably carried out when mobile station exists in the service area of any of the plurality of wireless LAN access point.

Also, the map database may store a setting data. In this case, the (b) choosing may include choosing a group of wireless LAN access points from the plurality of wireless LAN access point based on a preset connection fee as the setting data, and choosing the optimal wireless LAN access point from the group of wireless LAN access points.

Also, the map database further may store a setting data. In this case, the (b) choosing may include choosing a group of service areas from a plurality of service areas of the plurality of wireless LAN access points as the setting data; and choosing the optimal wireless LAN access point from the plurality of wireless LAN access point based on the group of service areas.

Also, the map database may store a setting data. The (b) choosing may include choosing a group of wireless LAN access points from the plurality of wireless LAN access points based on electric field strengths received when each of the plurality of wireless LAN access points transmits radio wave; and choosing the optimal wireless LAN access point from the group of wireless LAN access points.

Also, the (c) communicating may include storing each of the electric field strengths in communication with each of the plurality of wireless LAN access points in the map database.

Also, the map database may stores a setting data. In this case, the (b) choosing may include choosing a group of wireless LAN access points from the plurality of wireless LAN access points based on a traffic quantity of each of the plurality of wireless LAN access points; and choosing the optimal wireless LAN access point from the group of wireless LAN access points. In this case, in the (c) communicating may include storing the traffic quantity in communication with each of the plurality of wireless LAN access points in the map database.

Also, the (c) communicating may include communicating each of the plurality of wireless LAN access points to keep a QoS (Quality of Service) constant which is stored previously for each of the plurality of wireless LAN access points.

Also, the map data further a service data of buildings in a neighborhood of each of the plurality of wireless LAN access points. In this case, the (b) choosing may include displaying the service data of the optimal wireless LAN access point.

Also, it is desirable that the (c) communication includes informing the present position to the counter station when a data in the communication contains a keyword.

### BRIEF DESCRIPTION OF THE DRAWINGS

FIG. 1 shows a schematic diagram of wireless LAN communication system according to an embodiment of the present invention;

FIG. 2 is a block diagram showing the configuration of the mobile station according to the embodiment of the present invention;

FIG. 3 is a diagram of data stored in a communication block table according to the embodiment of the present invention;

FIG. 4 is a diagram showing data stored in a map database according to the embodiment of the present invention;

FIG. 5 is a flowchart showing an operation of the wireless LAN communication system in the embodiment;

FIG. 6 is a diagram showing the data stored in the map database according to another embodiment of the present invention;

FIG. 7 is a diagram of data stored in the map database according to another embodiment of the present invention;

FIG. 8 shows a schematic diagram showing the configuration of the wireless LAN communication system according to another embodiment of the present invention;

FIG. 9 is a diagram of data stored in the map database according to another embodiment of the present invention;

FIG. 10 is a flowchart showing an operation of the wireless LAN communication system according to the other embodiment of the present invention;

FIG. 11 is a schematic diagram showing the configuration of the wireless LAN communication system according to an embodiment of the present invention; and

FIG. 12 is a block diagram showing the configuration of the mobile station according to an embodiment of the present invention.

### DESCRIPTION OF THE PREFERRED EMBODIMENTS

A wireless network communication system of the present invention will be described below with reference to the attached drawings.

### First Embodiment

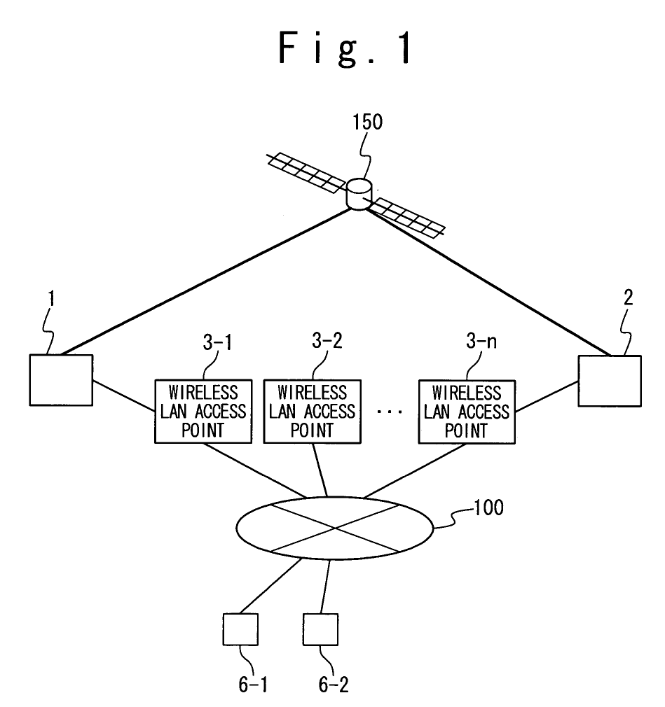

FIG. 1 shows the configuration of a wireless LAN communication system as the wireless network communication system according to the first embodiment of the present invention. Referring to FIG. 1, the wireless LAN communication system includes mobile stations 1 and 2, a plurality of wireless LAN access points 3-1 to 3-n (n is an integer more than one), a GPS (Global Positioning System) satellite 150, and a plurality of ISP servers 6-1 and 6-2. The mobile stations 1 and 2, the plurality of wireless LAN access points 3-1 to 3-n, the plurality of ISP server 6-1 and 6-2 are connected by a wireless communication network 100.

When the mobile station 1 communicates with the mobile stations 2 through the wireless communication network 100, the wireless stations 1 is connected to an optimal one of the plurality of wireless LAN access points 3-1 to 3-n automatically. The mobile stations 1 and mobile stations 2 communicate with a GPS satellite 150 using radio wave to measure the positions of them.

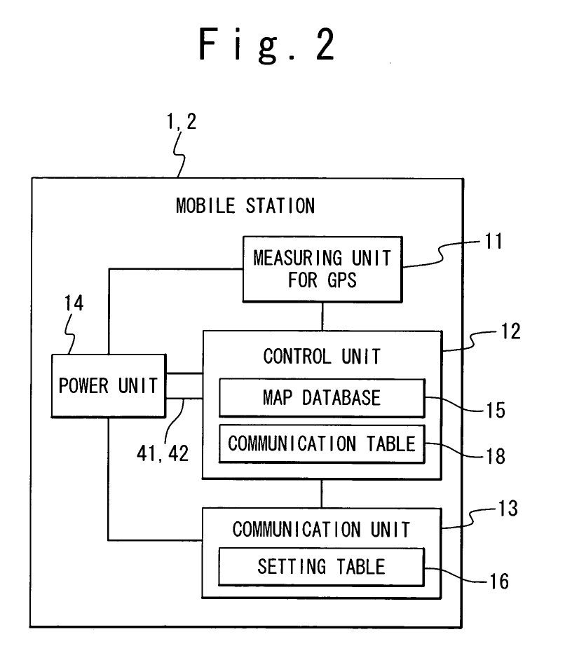

FIG. 2 shows the configuration of the mobile station 1. The mobile station 2 has the same configuration as the mobile station 1 and the description of the mobile station 2 is omitted.

The mobile station 1 includes a measuring unit for GPS 11, a control unit 12, a communication unit 13, a power unit 14, and an input unit and a display unit (both are not shown). The control unit 12 includes a map database 15 and a communication table 18, and the communication unit 13 includes a setting table 16. The power unit 14 supplies electric power to the measuring unit for GPS 11, the control unit 12, the communication unit 13, the input apparatus and the display apparatus.

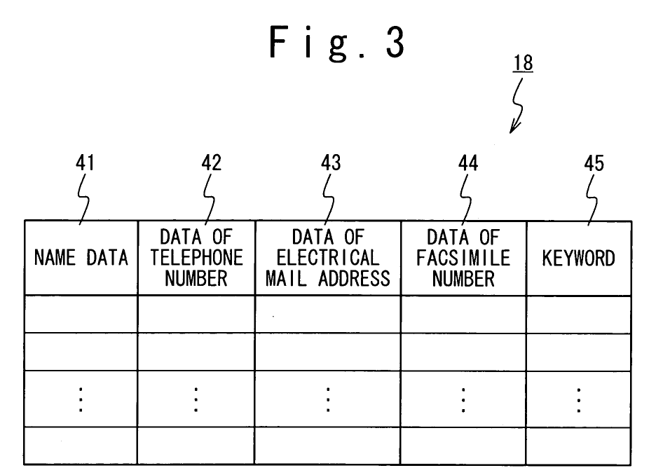

FIG. 3 shows a data to be stored in a communication table 18. Referring to FIG. 3, the communication table 18 includes a plurality of data of a counter station of communication, that is, name 41, a telephone number 42, an electrical mail address 43, a facsimile number, and a key word of the counter station. For example, the counter station is any of the mobile station 2, the ISP server 6-1 and the ISP server 6-2.

A user can communicate with the counter station by means of a telephone, an electrical mail, the Internet, by using the mobile station 1. For example, when the user of mobile stations 1 operates the input unit, the control unit 12 controls the display unit to display the data stored in communication table 18. The user of the mobile station 1 chooses the data of the mobile station 2 on the display unit. The control unit 12 controls the communication unit 13 to communicate with the mobile stations 2 on the basis of the chosen data.

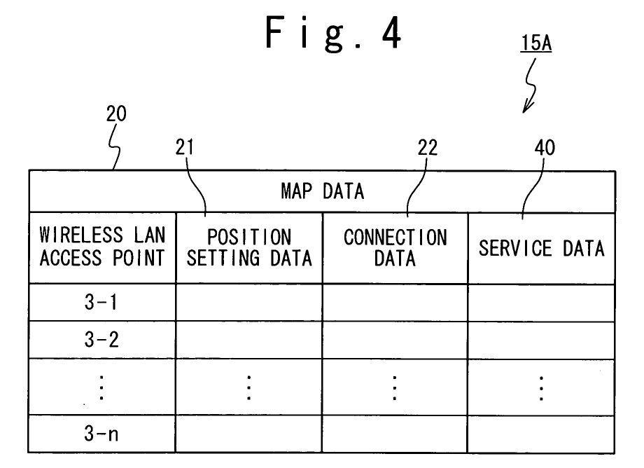

FIG. 4 shows a map data to be stored in a map database 15A. The map data 20 includes an identifier of each of the plurality of wireless LAN access points 3-1 to 3-n, position setting data 21 of the wireless LAN access point, connection setting data 22 used to communicate with the wireless LAN access point and service data 40 as data of or provided from buildings in the neighborhood of the wireless LAN access point. The buildings are a shop, a train station, a hospital and a school, etc. For Example, in case of the shop, the service data is like an announcement of bargain sale. In case of the train station, the service data is a map around the station.

The plurality of wireless LAN access points 3-1 to 3-n previously have a QoS (quality of Service). The connection setting data 22 includes an identifier of data of the wireless LAN access point and an encryption used to connect the wireless LAN access point.

The plurality of ISP servers 6-1 and 6-2 provide the latest map data 20 in accordance with a request from the mobile station 1.

The communication unit 13 of the mobile station 1 searches and chooses one from the plurality of ISP server 6-1 to 6-2 and downloads the latest map data 20 through the wireless communication network 100 from the chosen ISP server. To update the map data 20 stored in the map database 15A, the latest downloaded map data is written into the map database 15A.

Next, an operation of the wireless LAN communication system according to the first embodiment of the present invention will be described.

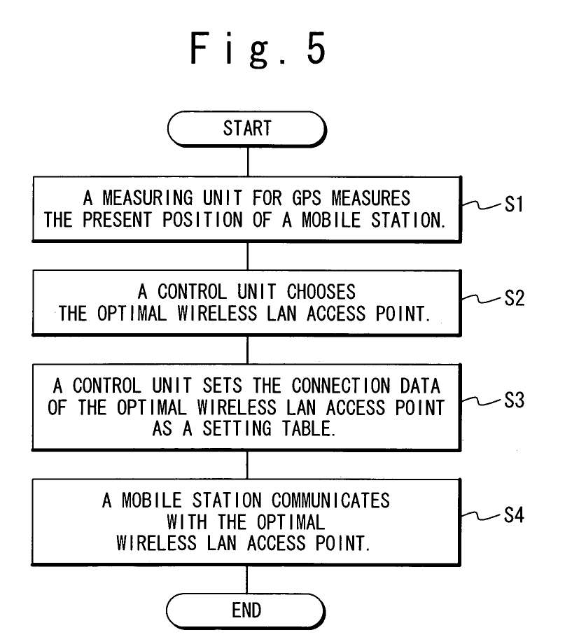

The measuring unit for GPS 11 in the mobile station 1 communicates with the GPS satellite 150 and measures the position of the mobile station 1 itself by radio wave, as shown in FIG. 5 (Step S1).

The control unit of the mobile station 1 refers to the map database 15 and chooses one from the plurality of wireless LAN access points 3-1 to 3-n which is the optimal and the nearest to the measured position of the wireless station 1 (Step S2).

When the wireless LAN access point 3-1 is chosen as the optimal wireless LAN access point in Step S2, the control unit 12 controls the display unit to display the service data 40 of the wireless LAN access point 3-1 which is the nearest to the position of the wireless station 1 itself. The control unit 12 of the mobile station 1 sets the identifier and the encryption, which is included in connection setting data 22 of the map data about the optimal wireless LAN access point 3-1, to the setting table 16 (Step S3).

The communication unit 13 of the mobile station 1 communicates with the mobile station 2 by referring to the setting table 16, namely on the basis of the connection setting data 22 about the wireless LAN access point 3-1. (Step S4)

When the mobile station 1 communicates with the mobile station 2 in the Step S4, the communication unit 13 of the mobile station 1 searches the ISP server 6-1 or the ISP server 6-2, and then downloads the latest map data 20 from the searched server through the wireless communications network 100 to update the map data in the map database 15A.

The plurality of wireless LAN access points 3-1 to 3-n previously have a QoS (quality of Service), as described above. Therefore, it is possible for the mobile station 1 to keep the QoS in the communication even after the roaming, namely after the hand-over from a previous wireless LAN access point to the wireless LAN access point 3-1.

Also, when the mobile station 1 communicates with the mobile station 2 in the Step S4, the mobile station 1 refers to the communication table 18. If the data given in the communication includes a kind of keyword 45, the mobile station 1 announces the position of the mobile station 1 to the counter mobile station 2 having the name 41 by means of any one of an electrical mail, a telephone and a facsimile. Supposing that the above-mentioned keyword 45 indicates data of accidents such as earthquake, hydraulic bore, snow avalanche, abduction and prowl, the data given in the communication is broadcast as news on the Internet (WWW). Further, supporting that the counter station having the name 41 is one related to parents of the user- of the mobile station 1, the news includes the data of the accident. As a result, the user of the mobile station 1 is able to inform the location of him of the parents.

As mentioned above, according to the wireless LAN communication system according to the first embodiment of the present invention, the connection setting data 22 of the optimal wireless LAN access point 3-1 is automatically set in the mobile station 1. Accordingly, the user needs not to consider about the identifier and the encryption of the connection setting data.

Further, a method of the communication (satellite communication) between the mobile station 1 and a GPS satellite 150 is different from a method of the communication (wireless LAN communication) between the mobile station 1 and the mobile station 2. Therefore, in the mobile station 1, the connection setting data 22 of the optimal wireless LAN access point 3-1 can be set regardless of whether or not the mobile station 1 exists in an area for any of the plurality of access pints 3-1 to 3-n. In this way, the roaming can be completed quickly. As a result, it is possible for the user of the mobile station 1 to start the wireless LAN communication promptly if the mobile station 1 is in the service area.

### Second Embodiment

The wireless LAN communication system according to the second embodiment of the present invention will be described bellow. The configuration of the wireless LAN communication system is the same as that of the first embodiment. Therefore, the same description is omitted.

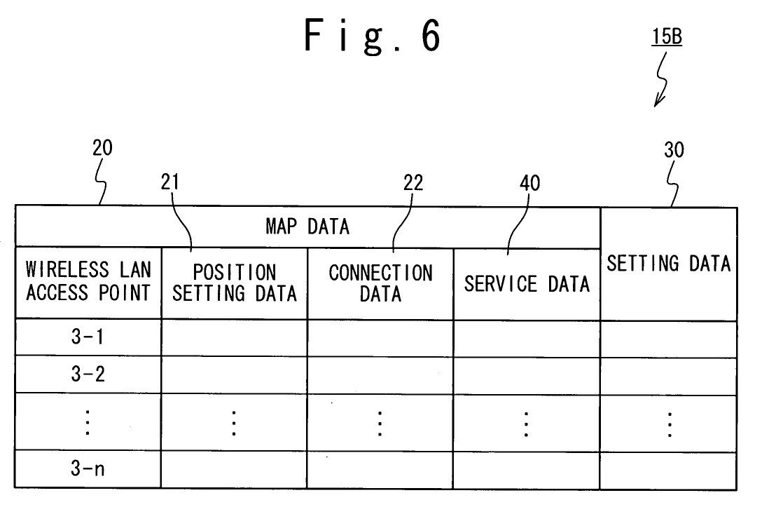

FIG. 6 shows data stored in the map database 15B. In the second embodiment, the map database 15B includes setting data 30 in addition to the map data 20 of the first embodiment. The setting data 30 is used to select plural candidates from the plurality of wireless LAN access points 3-1 to 3-n for the control unit 12. The number of the selected wireless LAN access point candidates x is described as 1<x≦n.

Next, an operation of the wireless LAN communication system in the second embodiment will be described below.

The second embodiment is different from the first embodiment in the Step S2 shown in FIG. 5. First, the control unit 12 of the mobile station 1 refers to the map database 15B in the step 2 following step S1, and selects the plural candidates, to which connection fees are previously set, from the plurality of wireless LAN access points 3-1 to 3-n.

Further, the control unit 12 of the mobile station 1 refers to the map database 15B, and selects one from the plural selected wireless LAN access point candidates which is the nearest wireless LAN access point to the position the mobile station 1, e.g., the wireless LAN access point 3-1.

After this step, the step S3 and the step S4 are executed.

As mentioned above, in the wireless LAN communication system in the second embodiment of the present invention, the mobile station 1 selects the wireless LAN access points to be connected with a priority as candidates, that is, the plural wireless LAN access points to which a connection fee is previously set. Then, the mobile station sets the optimal wireless LAN access point (the connection setting data of the optimal wireless LAN access point) from the selected plural wireless LAN access point candidates. Therefore, in addition to the effect of the first embodiment of the present invention, it is possible to set and connect the mobile station of the user to the optimal wireless LAN access point so as to match the request of the user in the second embodiment.

### Third Embodiment

The wireless LAN communication system according to the third embodiment of the present invention will be described bellow. The configuration of the wireless LAN communication system in the third embodiment is the same as that of the first embodiment. Therefore, the description of the configuration is omitted.

In the third embodiment, the map database 15B further includes setting data 30 set by the user in addition to the map data 20 of the first embodiment shown as FIG. 6. The setting data 30 is used to select plural wireless LAN access point candidates with a priority from the plurality of wireless LAN access points 3-1 to 3-n for the control unit 12. The number of the plural selected wireless LAN access point candidates X is described as 1<x≦n.

Next, an operation of the wireless LAN communication system in the third embodiment will be described bellow.

The third embodiment is different from the first embodiment in the Step S2 shown in FIG. 5. First, the control unit 12 of the mobile station 1 refers to the map database 15A in the step S2 following step S1, and selects plural service area candidates set previously from a plurality of service areas of the plurality of wireless LAN access points 3-1 to 3-n. Further, the control unit 12 of the mobile station 1 refers to the map database 15, and selects the nearest wireless LAN access point 3-1 to the position of the wireless LAN access point measured by the measuring unit for GPS 11 from the wireless LAN access points corresponding to the candidates. After this step, the step 3 and the step S4 are executed.

In the third embodiment, the control unit of the mobile station 1 does not select any wireless LAN access point if the mobile station 1 does not exist in the areas of the plurality of wireless LAN access points set previously, even if the nearest and optimal wireless LAN access point to the position of mobile station 1 exists in the plurality of wireless LAN access points 3-1 to 3-n.

As mentioned above, in the third embodiment of the present invention, the mobile station 1 chooses the service areas to be connected with a priority, that is the plural service areas previously set.

Then, the mobile station sets the optimal wireless LAN access point 3-1 (the connection setting data of the optimal wireless LAN access point) from the plural service points corresponding to the chosen area candidates. Therefore, in addition to the effect of the first embodiment of the present invention, it is possible to set/connect to the desired wireless LAN access point so as to match the need of the user in the third Embodiment.

### Forth Embodiment

The wireless LAN communication system according to the forth embodiment of the present invention will be described bellow. The configuration of the fourth embodiment is the same as that of the first embodiment. Therefore, the description of the configuration is omitted.

In the fourth embodiment, the map database 15B further includes the setting data 30 set by the user in addition to the map data 20 of the first embodiment shown as FIG. 6. The setting data 30 is used to choose the plural wireless LAN access point candidates with a priority which transmits radio wave in stronger electrical fields than a predetermined electric field from the plurality of wireless LAN access points 3-1 to 3-n.

The number of the plural wireless LAN access point candidates X is described as 1<x≦n.

Next, an operation of the wireless LAN communication system in the fourth embodiment will be described follow.

The fourth embodiment is different from the first embodiment in the Step S2 shown in FIG. 5.

First, the control unit 12 of the mobile station 1 refers to the map database 15B in the step S2 following step S1 and chooses plural wireless LAN access point candidates that the electrical fields received from them by the communication unit 13 are stronger than the predetermined electric field from the plurality of wireless LAN access points 3-1 to 3-n.

Further, the control unit 12 of the mobile station 1 refers to the map database 15 and chooses the nearest optimal wireless LAN access point 3-1 to the position itself measured by the measuring unit for GPS 11 from the plural wireless LAN access point candidates. After this step, the step S3 and the step S4 are executed.

Moreover, another operation of the wireless LAN communication system in the fourth embodiment will be described follow.

In the Step S4, the communication unit 13 of the mobile station 1 communicates with the chosen optimal wireless LAN access point, and the control unit 12 stores the data of the electrical field strength in the communication with the optimal wireless LAN access point to the map database 15. The data of the electrical field strength and the optimal wireless LAN data are stored in the relation to each other.

In the Step S1, the measuring unit for GPS 11 of the mobile station 1 communicates with GPS satellite 150 using radio wave to measure the position of mobile station 1. In the Step S2, the control unit 12 of the mobile station 1 refers to the map database 15B, and chooses the plural wireless LAN access point candidates that electrical fields received by the communication unit 13 are stronger than the predetermined electric field, from the plurality of wireless LAN access points 3-1 to 3-n. The control unit 12 of the mobile station 1 refers to the map database 15B and chooses the nearest optimal wireless LAN access point 3-1 to the position itself measured by the measuring unit for GPS 11 from the plural wireless LAN access point candidates. The control unit 12 of the mobile station 1 sets an identifier and an encryption, which is included in the connection setting data 22 for the optimal wireless LAN access point 3-1, to the setting table 16 (Step S3).

In the Step S4, the communication unit 13 of the mobile station 1 refers to the setting table 16, and communicates with the optimal wireless LAN access point 3-1 on the basis of the connection setting data 22 of the optimal wireless LAN access point 3-1. Then, the control unit 12 stores the data of the electrical field strength in the communication with the chosen optimal wireless LAN access point into the map database 15. The data of the electrical field strength and the optimal wireless LAN 3-1 are stored in relation to each other.

In this way, in the fourth embodiment of the present invention, the mobile station 1 chooses the wireless LAN access point candidates desired to be connected with a priority, that is, choosing the plural wireless LAN access point candidates which transmit the radio wave by the stronger electrical field than the electric field set previously. Then, the connection setting data 22 of the optimal wireless LAN access point is set from a record of the map database corresponding to the chosen wireless LAN access point. Therefore, in addition to the effect of the first embodiment of the present invention, it is possible to set/connect to the wireless LAN access point so as to match the need of the user in the forth embodiment.

### Fifth Embodiment

The wireless LAN communication system according to the fifth embodiment of the present invention will be described bellow. The configuration of the fifth embodiment is the same as that of the first embodiment. Therefore, the description of the configuration is omitted.

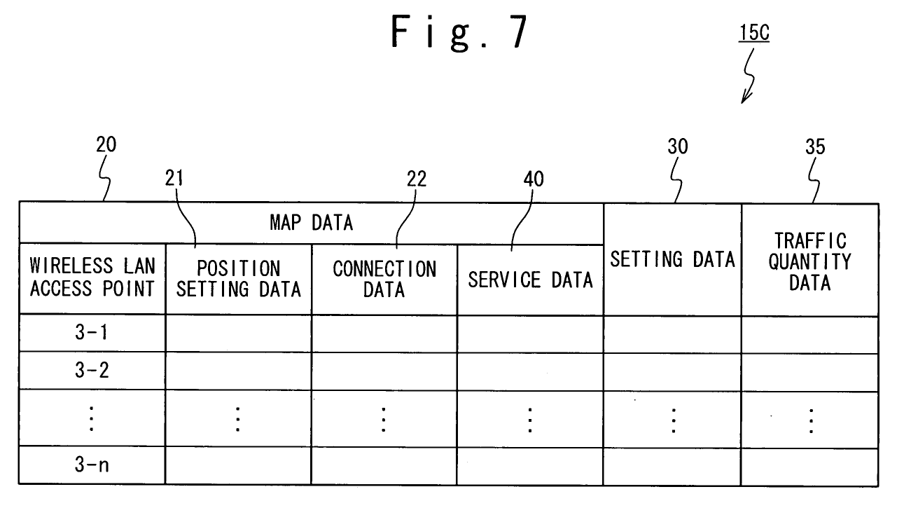

FIG. 7 shows data to be stored in the map database 15C. In the fifth embodiment, the map database 15C further includes setting data 30 set by the user and traffic quantity data 35 of the plurality of wireless LAN access points 3-1 to 3-n in addition to the map data 20 of the first embodiment.

Each of the plurality of wireless LAN access points 3-1 to 3-n communicates with the mobile station by different quantities of traffic. The setting data 30 indicates the plural wireless LAN access points, which communicates with the mobile station 1 in smaller traffic quantities than a traffic quantity previously set. The control unit 12 chooses one from said plural wireless LAN access points as the optimal wireless LAN access point. The number of the plural wireless LAN access points X is described as 1<x≦n.

Next, an operation of the wireless LAN communication system in the fifth embodiment will be described follow.

The fifth embodiment is different from the first embodiment in the Step S2 and Step S4 shown in FIG. 5.

First, the control unit 12 of the mobile station 1 refers to the map database 15 in the step S2 following step S1, and the control unit 12 chooses the plural wireless LAN access point candidates which communicate with the mobile station 1 by smaller traffic quantity from the plurality of wireless LAN access points 3-1 to 3-n. Further, the control unit 12 of the mobile station 1 refers to the map database 15 and chooses the nearest optimal wireless LAN access point 3-1 to the position itself measured by the measuring unit for GPS 11 from the plural wireless LAN access point candidates. After this step, the step S3 and the step S4 are executed.

Moreover, another operation of the wireless LAN communication system in the fifth embodiment will be described follow.

In the Step S4, the communication unit 13 of the mobile station 1 communicates with the chosen optimal wireless LAN access point, and the control unit 12 stores the data of the traffic quantity in the communication with the chosen optimal wireless LAN access point into the map database 15C. The data of the traffic quantity and the optimal wireless LAN data are stored in relation to each other.

In the Step S1, the measuring unit for GPS 11 of the mobile station 1 communicates with the GPS satellite 150 using radio wave to measure the position of mobile station itself.

In the Step S2, the control unit 12 of the mobile station 1 refers to the map database 15C, and chooses the plural wireless LAN access point candidates which communicate with the mobile station 1 in smaller traffic quantities from the plurality of wireless LAN access points 3-1 to 3-n. The control unit 12 of the mobile station 1 refers to the map database 15C and chooses the nearest optimal wireless LAN access point 3-1 to the position itself measured by the measuring unit for GPS 11 from the plural wireless LAN access point candidates. The control unit 12 of the mobile station 1 sets an identifier and an encryption, which is included in the connection setting data 22 for the optimal wireless LAN access point 3-1, to the setting table 16 (Step S3).

In the Step S4, the communication unit 13 of the mobile station 1 refers to the setting table 16, and communicates with the optimal wireless LAN access point 3-1 on the basis of the connection setting data 22 of the optimal wireless LAN access point 3-1. Then, the control unit 12 stores the data of the traffic quantity in the communication with the chosen optimal wireless LAN access point 3-1 to the map database 15C. The data of the traffic quantity and the optimal wireless LAN 3-1 are stored in relation to each other.

As mentioned above, in the fifth embodiment of the present invention, the mobile station 1 chooses the wireless LAN access point desired to connect with a priority, that is, the plural wireless LAN access point candidates which communicate with the mobile station 1 in smaller traffic quantities than the traffic quantity previously set. Therefore, in addition to the effect of the first embodiment of the present invention, it is possible to set/connect to the wireless LAN access point so as to match the need of the user in the fifth Embodiment.

### Sixth Embodiment

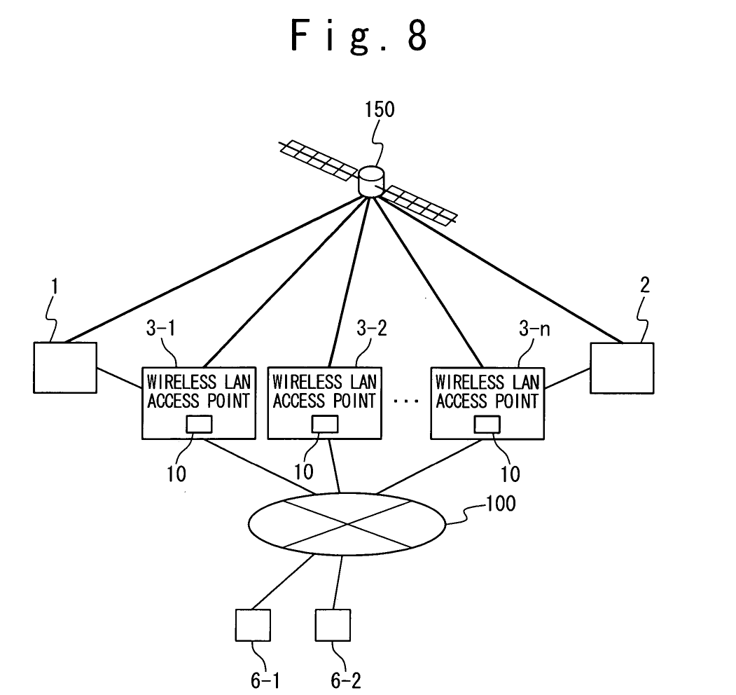

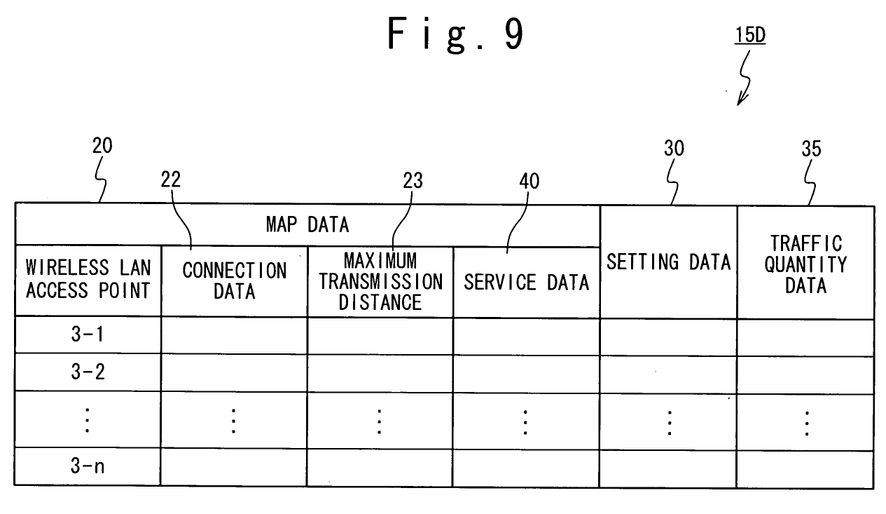

The wireless LAN communication system according to the sixth embodiment of the present invention will be described bellow. FIG. 8 shows the wireless LAN communication system according to the sixth embodiment of the present invention. The configuration of the wireless LAN communication system in the sixth embodiment is similar to that of the first embodiment. The sixth embodiment is different from the first embodiment in that a measuring unit for GPS 10, which has the same configuration and function as the measuring unit for GPS 11, is provided for each of the plurality of wireless LAN access points 3-1 to 3-n. Like the first embodiment, each of the mobile stations 1 and 2 has the measuring unit for GPS 11. FIG. 9 shows data to be stored in the map database 15D.

In the sixth embodiment, the map database 15D includes the map data 20 and the setting data 30 set in the second to fourth embodiments. The map database further includes a traffic quantity 35 for each of the plurality of wireless LAN access points 3-1 to 3-n in the fifth embodiment.

The map data of the map database 20 includes a maximum transmission distance of each of the plurality of wireless LAN access points 3-1 to 3-n instead of the data of the setting location point 21 of the wireless LAN access point 3-1. As a result, the identifier of each of the plurality of wireless LAN access points 3-1 to 3-n, the setting connection data 22 needed to communicate with the wireless LAN access point, and the maximum transmission distance of the wireless LAN access point are stored in relation to each other in the map data 20.

Next, an operation of the wireless LAN communication system in the sixth embodiment will be described follow. The sixth embodiment is different from the first to fifth embodiments in the Step S1 and Step S2 shown in FIG. 5.

In the Step S1, the measuring unit 11 for GPS in the mobile station 1 executes a differential positioning of GPS. The measuring unit 10 for GPS in each of the plurality of wireless LAN access points 3-1 to 3-n communicates with the GPS satellite 150 so as to measure the position of the wireless LAN access point. The communication unit 13 of the mobile station 1 communicates with the plurality of wireless LAN access points 3-1 to 3-n to collect the measured positions from the plurality of wireless LAN access points 3-1 to 3-n. The measuring unit 11 for GPS in the mobile station 1 calculates the distance (relative distance) between the mobile station 1 and a present position of each of the wireless LAN access points 3-1 to 3-n. To calculate the relative distance in fewer errors than above-mentioned relative positioning of GPS, it is desirable to carry out a differential GPS (DGPS measuring) or a real time kinematic GPS (RTK-GPS measuring).

First, the control unit 12 of the mobile station 1 refers to the map database 15 in the step 2 following step 1, and chooses the optimal wireless LAN access point 3-1 which is the nearest to the mobile station 1, on condition that the relative distances calculated by the measuring unit for GPS 11 is smaller than the maximum transmission distance of the wireless LAN access point 3-1 to 3-n. After this step, the step 3 and the step 4 are executed.

As mentioned above, in the sixth embodiment of the present invention, an automatic connection to a wireless LAN access point in the wireless LAN is carried out in the same way as the first embodiment. In the sixth embodiment, a method of the communication (satellite communication) between the measuring unit for GPS 11 of the mobile station 1 and a GPS satellite 150 is different from a method of the communication (wireless LAN communication) between the communication unit 13 of the mobile station 1 and the mobile station 2. Therefore, it is possible for the mobile station 1 to set the connection setting data of the optimal wireless LAN access point 3-1 regardless of whether or not the mobile station 1 exists in the service areas of the plurality of the access pint 3-1 to 3-n, so that the roaming is carried out quickly. As a result, it is possible for the user of the mobile station to start the wireless LAN communication promptly if the mobile station 1 is in the service area.

### Seventh Embodiment

The wireless LAN communication system according to the seventh embodiment of the present invention will be described bellow.

An operation of the wireless LAN communication system in the seventh embodiment will be described follow.

In the seventh embodiment, the control unit 12 of the mobile station 1 determines whether or not the mobile station 1 exists in the service area of any of the plurality of wireless LAN access points 3-1 to 3-n and executes the Step S1 to the Step S4 shown in the FIG. 5

The control unit 12 of the mobile station 1 distinguishes whether or not the mobile station 1 exists in the service area of any of the plurality of wireless LAN access points 3-1 to 3-n (Step S11). In the Step S11, when the communication unit 13 does not receive any radio wave form the plurality of wireless LAN access points 3-1 to 3-n, the control unit 12 distinguishes that the mobile station 1 does not exist in any service area, that is, the mobile station 1 is out of a radio area. Also, when the communication unit 13 receives radio wave from any of the plurality of wireless LAN access points 3-1 to 3-n and the electric field strength of the radio wave is weaker than an impermissible electric field strength previously set, the control unit 13 distinguishes that the mobile station 1 does not exist in the service area. The impermissible electric field strength for communication is weaker than the electric field strength previously set and is the electric field strength weak to the extent that the communication unit 13 is not permitted to communicate. The control unit 12 controls the power unit 14 to stop supplying power to the communication unit 13 (Step S12), when the mobile station 1 does not exist in the service area (Step S11-NO). In the Step S12, the control unit 12 transmits a signal to stop supplying the power for the communication unit 13 to the power unit 14, as shown in FIG. 2. The power unit 14 stops the supplying power to the communication unit 13 in response to the signal. Then, the mobile station executes the Step S1 to the Step S3.

The control unit 12 distinguishes again whether or not the mobile station 1 exists in the service area when the optical wireless LAN access point is chosen at the Step S2 (Step S13). In case that the mobile station 1 does not exist in the service area (Step S13-NO), the Step S1 to the Step S3 are executed again.

When the mobile station 1 exists in the service area and the power supply for the communication unit 13 is stopped (Step S11-YES, Step S14-YES), the control unit 12 of mobile station 1 controls the power unit 14 to supply the power to the communication unit 13 (Step S15). In the Step. S15, the control unit 12 transmits a signal to supply power for the communication unit 13 to the power unit 14, as shown in FIG. 2. The power unit 14 supplies the power to the communication unit 13 in response to the signal. Then, the mobile station executes the Step S4.

On the other hand, as a result of the distinguishing that the mobile station 1 exists in the service area (Step S11-YES, Step S13-YES, Step S14-NO), the mobile station 1 executes the Step S1 to the Step S4 like the first to sixth embodiments.

As mentioned above, in the seventh Embodiment of the present invention, the control unit 12 controls the power unit 14 to stop supply the power for the communication unit 13 when the control unit 12 distinguishes that the mobile station 1 does not exist in the service area.

If the control unit 12 distinguishes that the mobile station 1 exist in the service area, the control unit 12 controls the power unit 14 to supply the power for the communication unit 13. Therefore, when the mobile station 1 is out of the radio area, the electrical power consumption supplied to the measuring unit for GPS 11 and the control unit 12 by the power unit 14 is reduced, comparing with the electrical power consumption supplied to the measuring unit for GPS 11, the control unit 12 and the communication unit 13.

### Eighth Embodiment

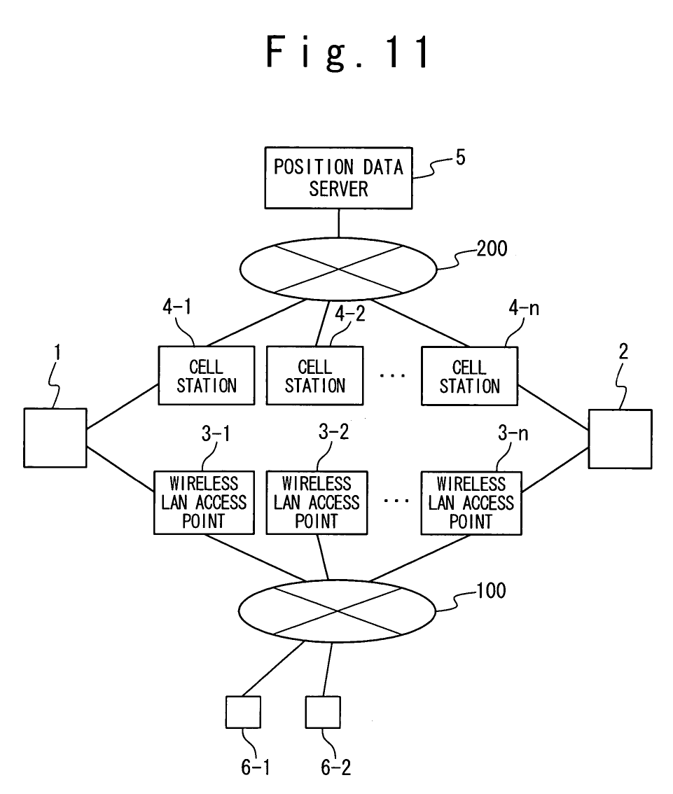

The wireless LAN communication system according to the eighth embodiment of the present invention will be described. FIG. 11 shows the configuration of the wireless LAN communication system in the eighth embodiment. Referring to FIG. 11, the wireless LAN communication system in the eighth embodiment includes a mobile station 1 and a mobile station 2, a plurality of wireless LAN access points 3-1 to 3-n, a plurality of ISP servers (a ISP server 6-1 and a ISP server 6-2), a plurality of cell stations (cell stations 4-1 to 4-m: m is an integer more than 1), and a position data server 5.

The mobile station 1 and the mobile station 2, the plurality of wireless LAN access points 3-1 to 3-n, and the plurality of ISP servers 6-1 and 6-2 are connected to a wireless communications network 100. Also, the mobile station 1 and the mobile station 2, the plurality of cell stations (the cell station 4-1 to the cell station 4-m), and the position data server 5 are connected to a wireless communication network 200 applied to a PHS (Personal Handyphone System).

The wireless LAN communication system according to the eighth embodiment of the present invention will be described follow. The description of the same configuration and operation as the first embodiment is omitted.

The mobile station 1 measures the position itself in communicating with the mobile station 2 by the PHS communication using radio wave as shown in FIG. 11. The mobile station 2 carries out the same operation as the mobile station 1. The position data server 5 includes a database (not shown) in which the setting position data is stored.

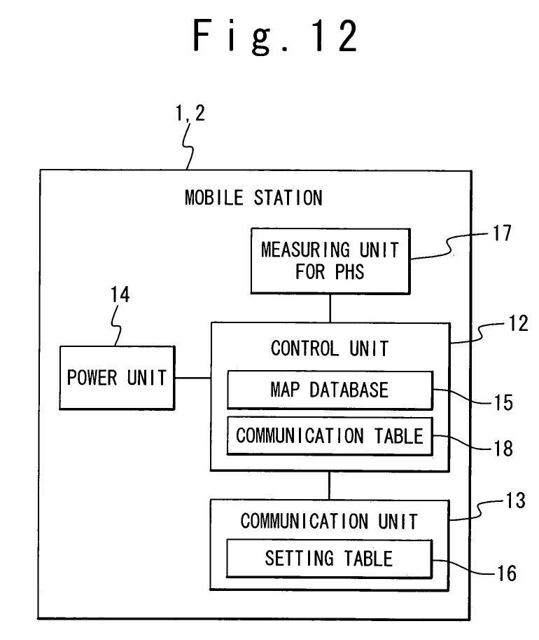

FIG. 12 shows the configuration of the mobile station 1. The mobile station 2 has the same configuration as the mobile station 1.

A mobile station 1 includes a measuring unit for PHS 17, a control unit 12, a communication unit 13, a power unit 14, and an input unit and a display unit (both are not shown). That is to say, the mobile station 1 includes the measuring unit for PHS 17 instead of the measuring unit for GPS 17.

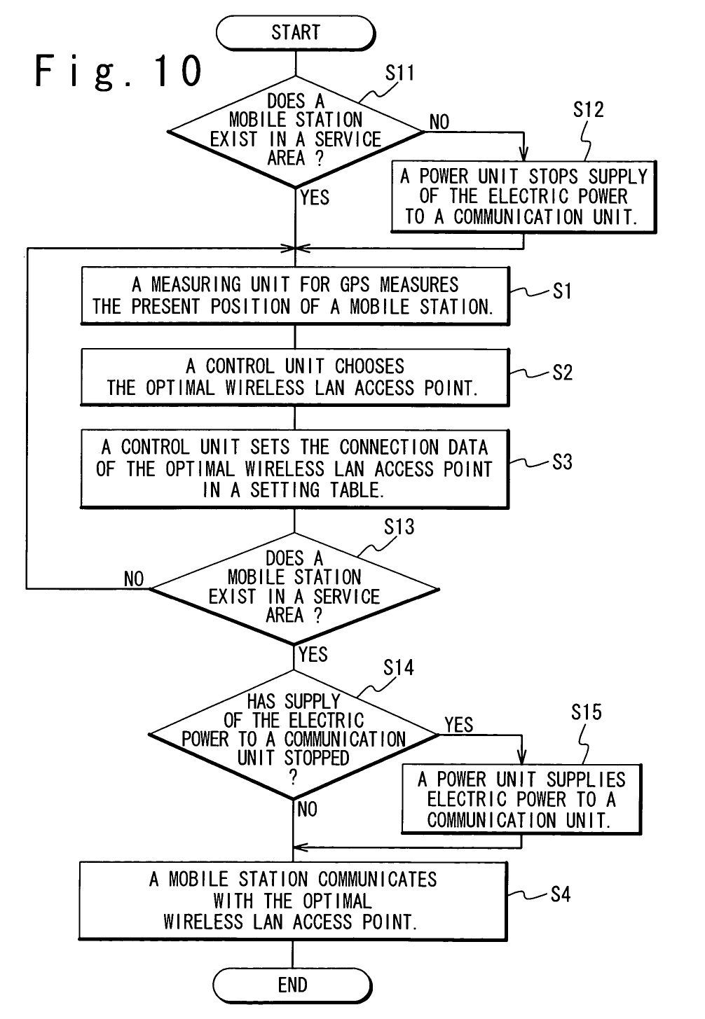

Next, an operation of the wireless LAN communication system in the eighth embodiment will be described below. The eighth embodiment is different from the first to fifth embodiments and the seventh embodiment in the Step S1 shown in FIG. 5 and FIG. 10. Because the measuring unit for PHS 17 measures the position of the mobile station 1, the Step S1 to the Step S4 described in the sixth embodiment is not applied.

In the Step S1 shown in the FIG. 5, the measuring unit for PHS 17 of the mobile station 1 is connected to one (the cell station 4-1 in this example) of the plurality of the cell stations 4-1 to 4-n communicating with the position data server 5 using radio wave. The location data server 5 refers to the database (not shown) and transmits the setting position data to the mobile station 1 using radio wave. The measuring unit for PHS 17 of the mobile station 1 determines the setting position of the cell station 4-1 as the position of the mobile station 1 through the transmission from the position data server 5.

As mentioned above, in the eighth embodiment of the present invention, like the first embodiment, the method of the communication (PHS communication) between the measuring unit for PHS 17 of the mobile station 1 and the position data server 5 is different from the method of the communication (wireless LAN communication) between the communication unit 13 of the mobile station 1 and the mobile station 2. Therefore, it is possible for the mobile station 1 to set the connection setting data of the optimal wireless LAN access point 3-1 regardless of whether or not the mobile station 1 exists in any of the service areas of the plurality of the access points 3-1 to 3-n, so that the roaming is carried out quickly. As a result, it is possible for the user of the mobile station 1 to start the wireless LAN communication promptly if the mobile station 1 is in the service area.

As it has been described up to this, in the present invention, it is possible to automatically set/connect to the wireless LAN access points and to execute the roaming quickly.

Also, it is possible to automatically set/connect the wireless LAN access point with the priority desired by the user. Thus, it is further possible to reduce the electric power consumption.

What is claimed is:

1. A mobile station comprising:
a measuring unit which measures a present position of said mobile station using radio wave;
a map database which stores a map data, which comprises an identifier to identify of each of a plurality of wireless LAN access points connecting to a wireless communications network, a connection data to communicate with said each wireless LAN access point and a position data indicating a setting position of said each wireless LAN access point;
a control unit which refers to said map database based on said present position of said mobile station to choose an optimal wireless LAN access point from said plurality of wireless LAN access points based on said present position of said mobile station; and
a communication unit which communicates with another station based on said connection data of said optimal wireless LAN access point.

2. The mobile station according to claim 1, further comprising a setting table,
wherein said measuring unit calculates a distance between said present position of said mobile station and said setting position of said each wireless LAN access point in response to completion of measuring said present position,
said map data further comprises a maximum transmission distance of said each wireless LAN access point, in addition to said identifier, said connection data and said position data of said each wireless LAN access point,
said control unit refers to said map database and chooses said nearest optimal wireless LAN access point from said present position of said mobile station on condition that said distance is smaller than said maximum transmission distance of said each wireless LAN access point,
said control unit sets said connection data of said optimal wireless LAN access point in said setting table, and
said communication unit refers said setting table to communicate with said optimal wireless LAN access point.

3. The mobile station according to claim 2, wherein said measuring unit measures said present position of said mobile station by a communication with GPS (Global Positioning System) satellite or a PHS (Personal Handyphone System) communication.

4. The mobile station according to claim 3, further comprising a power unit which supplies electric power to said measuring unit, said control unit and said communication unit,
wherein in case that said mobile station does not exist in a location where it is possible to communicate with any of said plurality of wireless LAN access points, said control unit controls said power unit to stop supplying electric power to said communication unit,
said measuring unit measures said present position by using said radio wave,
said control unit refers to said map database and chooses said optimal wireless LAN access point from said plurality of wireless LAN access points,
in case that said mobile station exists in a location where it is possible to communicate with any of said plurality of wireless LAN access points, said control unit controls said power unit to supply electric power to said communication unit, and
said communication unit communicates with said optimal wireless LAN access point based on said connection data of said optimal wireless LAN access point.

5. The mobile station according to claim 4, wherein said map database further contains a setting data provided for each of said plurality of wireless LAN access points and indicating a received electric field strength, and
said control unit refers to said setting data based on a preset received electric field strength to determines a group of wireless LAN access points and chooses said optimal wireless LAN access point from said group of wireless LAN access points.

6. The mobile station according to claim 5, wherein each of said plurality of wireless LAN access points transmits through radio wave to said mobile station,
said communication unit receives said radio wave to detect the received electric field strength of said radio wave, and
said control unit sets the received electric field strength in said setting data said each wireless LAN access points.

7. The mobile station according to claim 4, wherein said map database further contains a traffic quantity data indicating a traffic quantity in communication of said mobile station with each of said plurality of wireless LAN access points, and
said control unit refers to said traffic quantity data based on a preset traffic quantity data to determines a group of wireless LAN access points and chooses said optimal wireless LAN access point from said group of wireless LAN access points.

8. The mobile station according to claim 7, wherein said communication unit detects said traffic quantity data in a communication with each of said plurality of wireless LAN access points, and
said control unit sets the detected traffic quantity data in said setting data for said each wireless LAN access point.

9. The mobile station according to claim 4, wherein said map database further contains a setting data provided each of said plurality of wireless LAN access points to indicate a connection fee, and
said control unit refers to said setting data based on a preset connection fee to determines a group of wireless LAN access points and chooses said optimal wireless LAN access point from said group of wireless LAN access points.

10. The mobile station according to claim 4, wherein said map database further contains a setting data provided for each of said plurality of wireless LAN access points to indicate a service area of said each wireless LAN access point, and
said control unit refers to said setting data based on a preset service area to choose said optimal wireless LAN access point from said group of wireless LAN access points.

11. The mobile station according to claim 4, wherein said communication unit downloads the latest map data from an ISP server connected to said wireless communications network during said communication,
said latest map data contains an updated data of said optimal wireless LAN access point in said plurality of wireless LAN access points, and said control unit stores the latest map data in said map database.

12. The mobile station according to claim 4, wherein said communication unit communicates with each of said plurality of wireless LAN access points based on a setting data for said each wireless LAN access point to keep a QoS (Quality of Service) constant.

13. The mobile station according to claim 4, further comprising a display unit,
wherein said map database stores said map data which further comprises a service data of buildings in a neighborhood of each of said plurality of wireless LAN access points, and
said control unit refers to said map data and control said display unit to display said service data of the optimal wireless LAN access point.

14. The mobile station according to claim 4, further comprising:
a communication table which stores an identifier of a counter station, data of said counter station and a keyword,
wherein said communication unit refers to said communication table to inform said counter station of said present position corresponding to said keyword in case that a data in said communication includes said keyword.

15. A method of an automatic connection to a wireless LAN access point in a wireless LAN communication system, comprising:
(a) measuring a present position of a mobile station by a radio wave;
(b) choosing an optimal wireless LAN access point based on said present position from a plurality of wireless LAN access points by referring a map database storing a map data which stores an identifier of each of said plurality of wireless LAN access points connected to a wireless communications network, a connection point of said each wireless LAN access point and a connection data needed to communicate with said each wireless LAN access point;
(c) communicating with a counter station based on said connection data of said optimal wireless LAN access point;
(d) downloading the latest map data from an ISP server which is connected to said wireless communications network, when said communication is carried out;
(e) storing said latest map data into said map database as said map data.

16. The method according to claim 15, further comprising:
(f) calculating a distance between said present position and said connection point, wherein said plurality of wireless LAN access points measures said connection points using said radio wave;
(g) choosing said optimal wireless LAN access point which is the nearest to the mobile station from said plurality of wireless LAN access points on condition that said distance is smaller than a maximum transmission distance by referring to said map database.

17. The method according to claim 16, wherein:
said present position is measured by at least one of communication with GPS or communication with PHS.

18. The method according to claim 17, further comprising:
(h) setting said connection data of said optimal wireless LAN access point to a setting table,
wherein said (c) communicating includes acquiring said connection data of said optimal wireless LAN access point by referring to said setting table.

19. The method according to claim 18, wherein said (a) measuring and said (b) choosing is executed when said mobile station does not exist in a service area of any of said plurality of wireless LAN access point, and
said (c) communicating is carried out when mobile station exists in said service area of any of said plurality of wireless LAN access point.

20. The method according to claim 19, wherein said map database stores a setting data,
said (b) choosing comprises:
choosing a group of wireless LAN access points from said plurality of wireless LAN access point based on a preset connection fee as said setting data; and
choosing said optimal wireless LAN access point from said group of wireless LAN access points.

21. The method according to claim 19, wherein said map database further stores a setting data,
said (b) choosing comprises:
choosing a group of service areas from a plurality of service areas of said plurality of wireless LAN access points as said setting data; and
choosing said optimal wireless LAN access point from said plurality of wireless LAN access point based on said group of service areas.

22. The method according to claim 19, wherein said map database further stores a setting data,
said (b) choosing comprises:
choosing a group of wireless LAN access points from said plurality of wireless LAN access points based on electric field strengths received when each of said plurality of wireless LAN access points transmits radio wave;
choosing said optimal wireless LAN access point from said group of wireless LAN access points.

23. The method according to claim 22, wherein said (c) communicating includes:
storing each of said electric field strengths in communication with each of said plurality of wireless LAN access points in said map database.

24. The method according to claim 19, wherein said map database further stores a setting data,
said (b) choosing comprises:
choosing a group of wireless LAN access points from said plurality of wireless LAN access points based on a traffic quantity of each of said plurality of wireless LAN access points; and
choosing said optimal wireless LAN access point from said group of wireless LAN access points.

25. The method according to claim 24, wherein said (c) communicating includes:
storing said traffic quantity in communication with each of said plurality of wireless LAN access points in said map database.

26. The method according to claim 19, wherein said (c) communicating comprises:
communicating each of said plurality of wireless LAN access points to keep a QoS (Quality of Service) constant which is stored previously for each of said plurality of wireless LAN access points.

27. The method according to claim 19, wherein said map data further a service data of buildings in a neighborhood of each of said plurality of wireless LAN access points, and
said (b) choosing includes displaying said service data of the optimal wireless LAN access point.

28. The method according to claim 19, wherein said (c) communication includes informing said present position to said counter station when a data in said communication contains a keyword.
